(19) United States
(12) Patent Application Publication
(10) Pub. No.: US 2025/0110788 A1
(43) Pub. Date: Apr. 3, 2025

(54) System and Method for Offloading Autonomous Driving Tasks

(71) Applicant: Robert Bosch GmbH, Stuttgart (DE)

(72) Inventors: Lilly Wu, Shanghai (CN); Yifan Du, Shanghai (CN); Rui Zhang, Shanghai (CN); Xiangyu Wu, Shanghai (CN)

(21) Appl. No.: 18/886,798

(22) Filed: Sep. 16, 2024

(30) Foreign Application Priority Data
Sep. 28, 2023 (CN) 2023 1128 2386.5

(51) Int. Cl. G06F 9/50

(52) U.S. Cl. CPC G06F 9/5027

(57) ABSTRACT

A system and method for offloading autonomous driving tasks is disclosed. The system includes a plurality of computing nodes comprising one or a plurality of computing nodes located on a vehicle, one or a plurality of computing nodes located on edge devices, and one or a plurality of computing nodes located on cloud devices. The system further includes a modeling module configured to create a system model that comprises a communication latency between each pair of computing nodes among the plurality of computing nodes. The system also includes an allocation module configured to allocate a plurality of autonomous driving tasks of an autonomous driving service based on the system model in order to offload each autonomous driving task to one of the plurality of computing nodes, wherein the allocation is performed such that the end-to-end latency of the autonomous driving service is minimized.

This application claims priority under 35 U.S.C. § 119 to patent application no. CN 2023 1128 2386.5, filed on Sep. 28, 2023 in China, the disclosure of which is incorporated herein by reference in its entirety.

The present disclosure relates to a system and method for offloading autonomous driving tasks based on vehicle-edge-cloud collaboration.

### BACKGROUND

With the rapid development of the digital economy, intelligent connected vehicles (ICV: Intelligent connected vehicle) have become an important direction for the innovation and development of the automotive industry. As one of the main technical routes for ICVs, the vehicle-road-cloud collaborative ecosystem has attracted much attention in recent years.

Autonomous driving services (autonomous driving functions) comprise a range of computing tasks, such as perception, prediction, decision-making, and control. These tasks typically comprise computationally intensive tasks that require significant computing resources. If these tasks are to be completed only at the vehicle end, the vehicle would need to be equipped with high-performance sensors and computing chips, thereby significantly increasing the cost of the vehicle.

In this regard, building on the prior art, the offloading of computational tasks from the vehicle end to the edge end or the cloud end is proposed, thereby transforming standalone vehicle intelligence into autonomous driving services achieved through vehicle-road collaboration or edge-cloud collaboration. For example, task offloading decisions with the help of mathematical models or deep reinforcement learning have been studied in the literature. However, research in the prior art primarily involves scenarios that support edge applications, such as IoT applications, smart city applications, and the like. At present, there is no optimal autonomous driving task offloading solution across three layers (i.e., intelligent vehicle layer, edge computing layer, and cloud computing layer) in the prior art.

### SUMMARY

In view of the problems present in the prior art, one aspect of the present disclosure provides a system for offloading autonomous driving tasks, comprising: a plurality of computing nodes comprising one or a plurality of computing nodes located on a vehicle, one or a plurality of computing nodes located on edge devices, and one or a plurality of computing nodes located on cloud devices; a modeling module, configured to create a system model that comprises a communication latency between each pair of computing nodes among the plurality of computing nodes; and an allocation module, configured to allocate a plurality of autonomous driving tasks of an autonomous driving service based on the system model, in order to offload each autonomous driving task to one of the plurality of computing nodes, wherein the allocation is performed such that the end-to-end latency of the autonomous driving service is minimized.

Another aspect of the present disclosure provides a method for offloading autonomous driving tasks, comprising: creating a system model that comprises communication latency between each pair of computing nodes among a plurality of computing nodes, wherein the plurality of computing nodes comprise one or a plurality of computing nodes located on a vehicle, one or a plurality of computing nodes located on edge devices, and one or a plurality of computing nodes located on cloud devices; and allocating a plurality of autonomous driving tasks of an autonomous driving service based on the system model, in order to offload each autonomous driving task to one of the plurality of computing nodes, wherein the allocation is performed such that the end-to-end latency of the autonomous driving service is minimized.

Yet another aspect of the present disclosure provides a machine-readable storage medium having executable instructions stored thereon that, when executed, cause one or a plurality of processors to perform the method described above.

It should be noted that the above provides a brief summary of the main aspects of the present disclosure for a basic understanding of these aspects. This summary is not intended to describe all key or important elements, nor is it intended to limit the scope of any or all aspects. The purpose of this overview is to provide some implementations of these aspects in a simplified form as an introduction to the detailed descriptions that will follow.

### BRIEF DESCRIPTION OF THE DRAWINGS

A plurality of aspects of the disclosure will be described below in conjunction with accompanying drawings, which are provided to illustrate, but not limit, the plurality of aspects disclosed.

FIG. 1 is a schematic block diagram of an autonomous driving task offloading system according to one embodiment of the present disclosure.

FIG. 2 shows an example of the system depicted in FIG. 1.

FIG. 3 is a flowchart of an autonomous driving task offloading method according to one embodiment of the present disclosure.

FIG. 4 shows an example of a service dependency model.

FIG. 5 shows an example of a computing resource model.

FIG. 6 shows an example of autonomous driving task offloading based on the models in FIG. 4 and FIG. 5.

### DETAILED DESCRIPTION

### Overview

Embodiments of the present disclosure involve a method and system for autonomous driving task offloading, wherein a plurality of autonomous driving service tasks (AD tasks) are offloaded to a plurality of computing nodes under a vehicle-edge-cloud architecture.

According to examples of the present disclosure, factors in terms of resource constraints are considered in determining allocation strategies, and heterogeneous factors in terms of safety level requirements are also considered for different AD tasks. As a result, the task offloading system and method according to examples of the present disclosure are capable of meeting the safety requirements of autonomous driving applications.

According to examples of the present disclosure, the service dependency model represents the dependencies among a plurality of AD tasks of autonomous driving services and comprises a plurality of root nodes, i.e., the autonomous driving service has a plurality of data sources. The plurality of data sources may be data sources from the vehicle end, data sources from the road end, and data sources from the cloud end. The plurality of data sources may also be a plurality of perception data sources from multimodal sensors. This is particularly attractive for applications in an intelligent connected vehicle (ICV) collaborative ecosystem.

According to examples of the present disclosure, even in the presence of both secure and insecure hardware devices under a vehicle-edge-cloud architecture, critical AD tasks can also be offloaded to hardware devices with a high safety level, thereby ensuring the safety of autonomous driving services.

The AD task offloading solution according to examples of the present disclosure, satisfies software security requirements while taking into account the heterogeneity between hardware devices and between hardware and software, as well as the dependencies between AD tasks, achieving end-to-end latency minimization for autonomous driving services.

The offloading solution according to examples of the present disclosure may be implemented online, for example, based on real-time measurement results, without relying on historical data.

### Exemplary Systems

The following describes specific embodiments of the present disclosure with reference to the accompanying drawings.

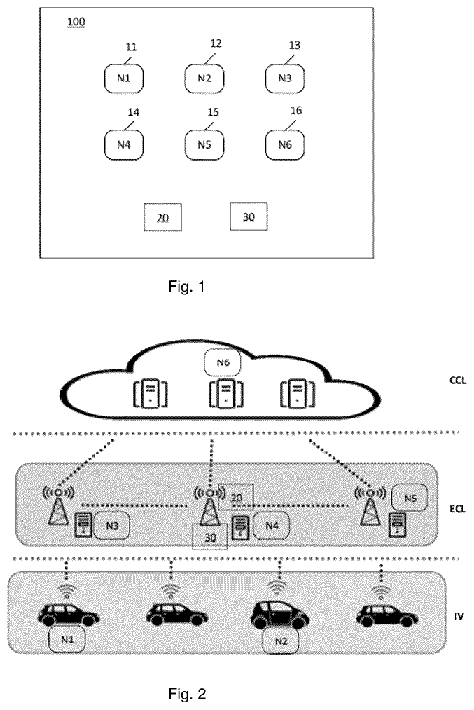

FIG. 1 shows a system 100 (hereinafter referred to as system 100) for offloading AD tasks according to one embodiment of the present disclosure. In examples of the present disclosure, the system 100 may be understood as an intelligent vehicle collaborative ecosystem under a vehicle-edge-cloud (also referred to as vehicle-road-cloud in some places) architecture.

As shown in FIG. 1, the system 100 comprises a plurality of computing nodes 11-16, a modeling module 20, and an allocation module 30. These computing nodes 11-16 are capable of communicating with each other. The plurality of computing nodes 11-16 comprise one or a plurality of vehicle nodes located on a vehicle, one or a plurality of edge nodes located on edge devices, and one or a plurality of cloud nodes located on cloud devices. The modeling module 20 creates a system model based on the attributes of the software and hardware. For example, the system model comprises a service dependency model representing dependencies among AD tasks and a computing resource model representing the available computing resources of computing nodes. The allocation module 30, leveraging the created system model, allocates one or a plurality of AD tasks to one or a plurality of these computing nodes 11-16 to minimize the end-to-end latency associated with the autonomous driving service related to that one or plurality of AD tasks. Furthermore, it ensures that the safety level requirements of each AD task are compatible with the safety level of the computing node it is offloaded to; for example, the safety level of the offloaded computing node to is not lower than the safety level required by the AD task. Additionally, it ensures that AD tasks are offloaded to computing nodes adjacent to upstream or downstream nodes they strongly depend on.

In one example, the modeling module 20 may be disposed on one computing node among the plurality of computing nodes 11-16. The modeling module 20 may also be disposed on the working end of a platform (for example, a central controller in a centralized system architecture) that is independent of the system 100 but able to communicate and connect with the system 100. Similarly, the allocation module 30 may be disposed on one computing node among the plurality of computing nodes 11-16. The allocation module 30 may also be disposed on the working end of a platform (for example, a central controller in a centralized system architecture) that is independent of the system 100 but able to communicate and connect with the system 100.

The modeling module 20 and the allocation module 30 may be implemented by using hardware, software, or a combination of software and hardware. For hardware implementation, it may be realized using one or more dedicated integrated circuits (ASICs), digital signal processors (DSPs), data signal processing devices (DSPDs), programmable logic devices (PLDs), field-programmable gate arrays (FPGAs), processors, controllers, microcontrollers, microprocessors, electronic units designed to perform their functions, or combinations thereof. For software implementation, it may be realized using microcode, program code, or code segments, and they may also be stored in machine-readable storage media such as storage components.

The naming of the modeling module 20 and the allocation module 30 should be understood as logical (functional) descriptions, rather than limitations on physical form or configuration. They may be further divided into sub-modules based on function. The modeling module 20 and the allocation module 30 may be implemented on the same chip or circuit, or separately on different chips or circuits.

Here, “autonomous driving service” may be understood as an autonomous driving function, which may comprise one or a plurality of AD tasks. For example, lane assist is an autonomous driving function that may comprise three AD tasks: lane detection, driving route monitoring, and driving route correction. “The end-to-end latency of the autonomous driving service is minimized” refers to minimizing the duration required to complete the autonomous driving service. That is, the duration from when the signal enters the input source node to when it flows to the last computing node is minimized. In one example, target detection is performed at the road end, then the target detection results are processed at the cloud end, and the processed results are finally sent to the vehicle end. In this example, “the end-to-end latency of the autonomous driving service is minimized” refers to minimizing the duration from when the signal enters the first computing node (the device performing target detection at the road end) to when it flows to the last computing node (the vehicle end).

FIG. 2 shows one example of the system 100 depicted in FIG. 1 under a vehicle-edge-cloud architecture. As shown in FIG. 2, the plurality of computing nodes comprise computing nodes distributed in an intelligent vehicle layer (IV: intelligent vehicle, referred to as the vehicle end in some instances below), computing nodes deployed on an edge computing layer (ECL, also referred to as the edge end in some instances below) and computing nodes deployed on a cloud computing layer (CCL, also referred to as the cloud end in some instances below). For example, the computing nodes N1 and N2 are deployed on an IV in the IV layer, the computing nodes N3-N5 are deployed on an edge computing device in the ECL, and the computing node N6 is deployed on a cloud server in the CCL. The modeling module 20 and the allocation module 30 are disposed on the same edge computing device in the ECL.

It should be understood that FIG. 2 shows only one example of a layout of the computing nodes, modeling module, and allocation module of the system 100, which may also be arranged in other ways.

### Vehicle-Edge-Cloud Architecture

The characteristics of each of the three layers of the vehicle-edge-cloud architecture are described below. The characteristics of each layer also apply to the computing nodes deployed on that layer.

The intelligent vehicle layer comprises a plurality of IVs. Computing nodes deployed on IVs may comprise high-performance embedded systems and onboard perception systems (for example radar, cameras, and high-precision maps). IVs may communicate with other vehicles via V2V (vehicle-to-vehicle) or communicate with roadside infrastructure or cloud servers via V2X (vehicle-to-everything).

The ECL comprises a plurality of edge computing devices. The edge computing devices may comprise road end computing unit, base stations, mobile edge computing (MEC), and edge servers. These edge devices may have different architectures, may have different resource capacities, and they may be widely distributed geographically. In one example, the edge computing devices and the IVs are located in the same intranet and therefore have sufficient bandwidth resources between them. The edge servers may have predetermined computing capabilities and storage capabilities, allowing them to process specific AD tasks offloaded from IVs.

The CCL comprises a plurality of cloud servers (for example a remote server in a data center). Cloud servers have powerful computing capabilities and scalable storage capabilities, allowing computationally intensive tasks to be offloaded to cloud servers and run on them with high performance. The cloud servers may exchange information with vehicles through edge servers. Due to the greater distance between cloud servers and edge servers compared to the distance between edge servers and vehicles, the communication latency between cloud servers and edge servers is greater than the communication latency between edge servers and vehicles.

According to examples of the present disclosure, under the above vehicle-edge-cloud architecture, an allocation solution for offloading AD tasks among vehicles, edge computing devices, and cloud servers is determined, which is capable of obtaining an offloading strategy that minimizes the end-to-end latency of autonomous driving services while satisfying constraints related to hardware device heterogeneity, resource demand heterogeneity, new safety requirements, and considering dependencies among AD tasks. The relevant constraints and considerations are specified below.

### Heterogeneity Among Computing Nodes

Computing nodes located in different layers exhibit differences in system architecture, resource capacity, and safety levels. For example, the system architecture of the infrastructure in the ECL may be ARM, X86, or FPGA to meet the customized requirements (for example lightweight or low power) of different applications. Second, computing devices located in different layers have varying resource capacities. For example, in terms of resource capacity, cloud computing devices are the largest, IVs are the smallest, and edge computing devices are in the middle. In the ECL, resource capacities vary greatly depending on the device type of the computing node. Third, some AD tasks have strict requirements for the safety level of the hardware they run on, which requires them to run on computing nodes with a high safety level. For example, to ensure the accuracy of perception, tasks related to perception are run on hardware devices with a high safety level and low error rate. Due to the high safety level, the cost of the hardware device will also be high. Therefore, considering costs, the hardware in a vehicle-edge-cloud architecture comprises secure and insecure hardware devices (with different safety levels).

It should be understood that both “safety” and “safety level” in the present disclosure refer to the levels of safety (Automotive Safety Integrity Level, ASIL) determined according to the ISO 26262 standards based on the degree of safety risk, of which Level D is the highest level and requires the most demanding safety requirements.

### Heterogeneity Among AD Tasks

Different AD tasks may use different programming languages, so their resource requirements may be different. For example, object detection tasks based on deep learning require GPU resources, while object tracking tasks based on a Kalman filter require CPU resources rather than GPU resources. In addition, some AD tasks have a strong dependency on input sources and need to be offloaded to computing nodes that are close to these input source nodes.

### Dependency Among AD Tasks

Autonomous driving services include perception tasks, prediction tasks, planning tasks, and control tasks, which are interdependent. For example, these tasks exchange information through a lightweight communication protocol (ROS2). The dependency relationships between these tasks include both linear and graphical ones (for example, using a directed acyclic graph to express the dependency relationships among a plurality of AD tasks). For example, the perception fusion task relies on results from a camera object tracker, a radar object tracker, a lidar object tracker, and visibility grid perception.

### Communication Latency Between Computing Nodes

Autonomous driving services have strict requirements for latency, for example, requiring completion within tens or hundreds of milliseconds. The latency of one autonomous driving service comprises the execution time of each AD task and the communication latency between different computing nodes. In the examples of the present disclosure, the end-to-end latency of the AD tasks comprises only the communication latency, and ignores the execution time of the AD tasks. The end-to-end latency may comprise communication latency between different layers or between different computing nodes in the same layer.

### Exemplary Methods

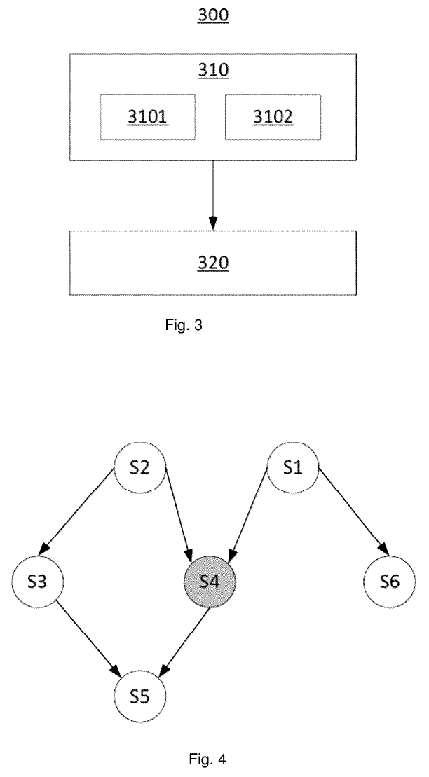

FIG. 3 the method 300 for autonomous driving task offloading according to one embodiment of the present disclosure. The method 300 may be implemented by way of the foregoing system 100. Therefore, the foregoing description regarding the system 100 is also applicable to this method.

In block 310, the model module 20 creates the system model. The system model comprises the communication latency between each pair of computing nodes among a plurality of computing nodes. The system model may also comprise dependencies and heterogeneity among a plurality of AD tasks, heterogeneity among a plurality of computing nodes, and the resource attributes of each computing node.

In one example, modeling module 20 creates a service dependency model (block 3101) by way of a directed acyclic graph (DAG) and creates a computing resource model (block 3102) by way of a bi-directional graph.

In block 3101, the modeling module 20 creates a DAG with a plurality of nodes and a plurality of edges. Each node represents an AD task. Each edge represents the data dependency between the two AD tasks it connects. The arrow on each edge indicates the direction of data flow. Each AD task has attribute parameters, comprising requirements for computing resources and safety levels, as well as dependencies on other AD tasks (for example, upstream or downstream AD tasks). These attribute parameters may be represented by a set of numerical values.

In examples of the present disclosure, the DAG may have a plurality of root nodes, i.e., the autonomous driving service represented by the DAG has a plurality of data input sources. The plurality of data input sources may comprise data input sources located in different layers, for example, two or more data input sources located at the cloud end, data input sources located at the edge end, and data input sources located at the vehicle end. The plurality of data input sources may also comprise data input sources from sensors of different modalities, for example, perception data from LiDAR, perception data from a camera, and map data from a high-definition map. Instances with a plurality of root nodes are particularly suitable for applications in autonomous driving services because having a plurality of data input sources can significantly enhance the efficiency of autonomous driving services (for example, more accurate driving decisions, faster training convergence, etc.).

FIG. 4 shows an example of using a DAG to represent the service dependency model. As shown in FIG. 4, the service dependency model comprises 6 nodes (S1-S6), i.e., the autonomous driving service represented by the model comprises 6 AD tasks. The autonomous driving service has a plurality of data input sources, i.e., the nodes S1 and S2 in FIG. 4. In addition, the node S4 in FIG. 4, shaded in gray, indicates that this node requires a higher safety level compared to the other nodes (unshaded nodes).

In block 3102, the modeling module 20 creates a bi-directional graph with a plurality of nodes and a plurality of edges. Each node represents a computing node having attribute parameters that comprise resource type and available computing resources. Each edge represents a communication link between the two nodes it connects, equipped with a transmission bandwidth. Data may be transmitted bidirectionally between two nodes (e.g., one node and another node) connected by each edge, i.e., the data may be transferred from one node to another node and vice versa.

In examples of the present disclosure, the computing resource model remains unchanged during each execution of task offloading. That is, during the process of data flowing from the first node to the last node in an autonomous driving service, the computing resource model remains unchanged. After completing the current task offloading, the modeling module 20 may adjust the computing resource model to reflect the current state of the computing resources in the system 100. For example, after completing the current task offloading, the available computing resources and safety levels of each node may change.

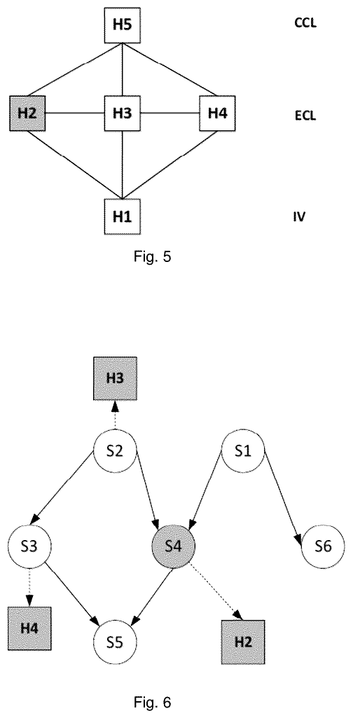

FIG. 5 shows an example of representing the computing resource model with a bi-directional graph, which shows the computational resource model under a vehicle-edge-cloud architecture. As shown in FIG. 5, the model comprises five computing nodes, namely: one computing node H1 at the vehicle end, three computing nodes H2-H4 at the edge end (for example, these three nodes comprise a computing node on a traffic signal pole, a computing node buried underground, and a computing node at a base station), and one computing node at the cloud data center. Among these computing nodes, the node H2 shaded in gray has a higher safety level compared to the safety levels of the other (unshaded) nodes.

Returning to FIG. 3, in block 320, the allocation module 330 allocates a plurality of AD tasks of autonomous driving services based on the created model, offloading each AD task to one computing node among a plurality of computing nodes. This allocation strategy minimizes the end-to-end latency of the autonomous driving services. For example, referring to FIG. 6, the duration for data to flow in from the nodes S1 and S2 and flow out from the node S5 is the shortest. This allocation strategy also ensures that tasks with high safety requirements are offloaded to computing nodes with high safety levels. For example, with reference to FIG. 6, the task S4, which requires a high safety level, is offloaded to the node H2, which has a high safety level. This allocation strategy also ensures that AD tasks strongly associated with a specific computing node are offloaded to a computing node adjacent to that specific computing node. For example, referring to FIG. 6, if the task S2, serving as an input source, is offloaded to the node H3 (i.e., a computing node in the edge layer), and the task S3 is heavily dependent on the input source, in this scenario, the task S3 should be offloaded to a node adjacent to the node H3 to reduce communication latency between the two, for example, the task S3 may be offloaded onto the computing node H4 in the edge layer.

In one example, the allocation module 30 offloads two interdependent AD tasks to a pair of computing nodes with a communication latency less than a latency threshold. In this example, the distance between the pair of offloading nodes is constrained by the latency threshold. The latency threshold is predetermined and can be adapted to suit different application scenarios as needed.

In one example, the allocation module 30 assigns one or a plurality of AD tasks to one or a plurality of computing nodes by computing the optimal solution to the objective function. The specific implementations of this example are described below. First, the number of AD tasks is set as N, and the total number of computing nodes at the vehicle end, edge end and cloud end is set as M. The dependency relationships among N AD tasks are represented by an N*N matrix called the AD task dependency matrix, denoted as D_{N×N}. The elements of the matrix D_{N×N} are represented as {0, 1}, wherein Dᵢₓⱼ=1 indicates that the task Sᵢ depends on the task Sⱼ, and vice versa. In the computing resource model, the communication latency between the computing nodes is represented by the computing resource matrix L_{M×M}. The values of the elements in this matrix represent the communication latency between two computing nodes. For two computing nodes that are not connected, the communication latency between them is infinite (i.e., the values of the corresponding matrix elements are infinite). The matrix L_{M×M} is a symmetric matrix. In this case, allocation module 30 establishes an allocation strategy to offload N AD tasks to M computing nodes, represented by an N*M offloading matrix A_{N×M}. The elements of the offloading matrix A_{N×M} are represented as {0, 1}, wherein Aᵢₓⱼ=1 indicates that the task Sᵢ is offloaded to the computing node Hⱼ. The predetermined allocation may be represented in the offloading matrix, for example, by pre-filling some elements in the offloading matrix A_{N×M} to indicate this predetermined allocation.

Next, N AD tasks are set to be offloaded at once. For each task Sᵢ, its computing resource requirements are characterized as Rᵢ. Rᵢ may be a vector representing the requirements for resource type and computing power. For each computing node Hⱼ, its available resources are expressed as Cⱼ. The Cⱼ may also be a vector. During allocation, Cⱼ should match the Rᵢ of the tasks allocated to that computing node.

The above settings may be expressed as follows:
N AD tasks are expressed as: S={s₁, s₂, s₃, . . . , s_{N}}, interdependencies between them are represented by the AD task dependency matrix D_{N×N}, where Dᵢⱼ∈{0, 1}. For each AD task Sᵢ, its resource requirements are represented as Rᵢ; and
the M nodes across the three layers are represented as H={h₁, h₂, h₃, . . . , h_{M}}, with the communication latency between each pair of nodes expressed as L_{M×M}∈R. For each node hᵢ, its available resources are represented as Cⱼ.
   Based on the above settings, the objective function is expressed as:

$$Min ( U ) = I \times L \qquad ( 1 )$$

$$I = D \times A \qquad ( 2 )$$

wherein A is the target offloading matrix, D is the AD task dependency matrix described above, I is an intermediate variable, and I=D×A represents the plurality of AD tasks expressed by the matrix D according to the target offloading matrix. L is the computing resource matrix described above. Min (U)=I×L represents the minimum total latency in the execution of all tasks in the task matrix (i.e., the end-to-end latency of autonomous driving services).

The process of computing the optimal solution to the above objective function described above involves adjusting the offloading matrix A to minimize the total latency U. The offloading matrix A obtained when obtaining the optimal solution is the target offloading matrix.

In addition, in the process of computing the optimal solution to the objective function described above, the following constraints need to be satisfied:
ΣᵢRⱼAⱼᵢ≤Cⱼ, wherein j=1, . . . , N. This constraint indicates that the resources required by tasks running on the node hᵢ do not exceed the available resources Cⱼ,
ΣᵢAⱼᵢ=1, wherein, i=1, . . . , M. This constraint indicates that the task Sⱼ is only offloaded to one node and runs on that node only.
   The present disclosure also provides a machine-readable storage medium having executable instructions stored thereon that, when executed, cause one or a plurality of processors to perform the AD task offloading method described above.

It should be understood that processors may be implemented using electronic hardware, computer software, or any combination thereof. Whether these processors are implemented as hardware or software will depend on the specific application and overall design constraints imposed on the system. As an example, the processors, any portions thereof, or any combinations of the processors provided herein may be implemented as microprocessors, microcontrollers, digital signal processors (DSPs), field-programmable gate arrays (FPGAs), programmable logic devices (PLDs), state machines, gate logic, discrete hardware circuits, and other suitable processing components configured to perform various functions described in the present disclosure. The functions of the processors, any portions thereof, or any combinations of the processors provided herein may be implemented as software executed on platforms such as microprocessors, microcontrollers, DSPs, or other suitable platforms.

It should be understood that software may be broadly construed as representing instructions, instruction sets, code, code segments, program codes, programs, subprograms, software modules, applications, software applications, software packages, routines, subroutines, objects, execution threads, processes, functions, and the like. Software may reside on computer-readable media. Computer-readable media may comprise, for example, storage devices such as magnetic storage devices (e.g., hard drives, floppy disks, magnetic tapes), optical disks, smart cards, flash devices, random-access memory (RAM), read-only memory (ROM), programmable ROM (PROM), erasable PROM (EPROM), electrically erasable PROM (EEPROM), registers, or removable disks. Although memory is depicted as being separate from the processor in several aspects provided in the present disclosure, memory may also be located within the processor (e.g., cache or registers).

Although some embodiments are described above, these embodiments are provided by way of example only, and are not intended to limit the scope of the present disclosure. The appended claims and their equivalents are intended to cover all modifications, substitutions and changes made within the scope and subject matter of the present disclosure.

What is claimed is:

1. A system for offloading autonomous driving tasks, comprising:
a plurality of computing nodes including one or a plurality of computing nodes located on a vehicle, one or a plurality of computing nodes located on edge devices, and one or a plurality of computing nodes located on cloud devices;
a modeling module configured to create a system model that comprises a communication latency between each pair of computing nodes among the plurality of computing nodes; and
an allocation module configured to allocate a plurality of autonomous driving tasks of an autonomous driving service based on the system model in order to offload each autonomous driving task to one of the plurality of computing nodes, wherein the allocation is performed such that the end-to-end latency of the autonomous driving service is minimized.

2. The system according to claim 1, wherein:
the system model comprises a service dependency model and a computing resource model,
the service dependency model comprises the dependencies and heterogeneity among the plurality of autonomous driving tasks and the ASIL safety level required by each autonomous driving task, and
the computing resource model comprises the heterogeneity among the plurality of computing nodes, the communication latency between each pair of computing nodes, and the resource types and available computing resources of each computing node.

3. The system according to claim 2, wherein the allocation module is configured to allocate the plurality of autonomous driving tasks based on the service dependency model and the computing resource model such that each autonomous driving task is offloaded to a computing node with an ASIL safety level higher than or equal to the ASIL safety level required by that autonomous driving task.

4. The system according to claim 2, wherein the allocation module is configured to allocate the plurality of autonomous driving tasks based on the service dependency model and the computing resource model such that two autonomous driving tasks that depend on each other are offloaded to a pair of computing nodes with a communication latency less than a latency threshold.

5. The system according to claim 2, wherein the allocation module is configured to allocate the plurality of autonomous driving tasks based on the service dependency model and the computing resource model such that each autonomous driving task is allocated to a computing node with resource types consistent with the required resources of the task, and each autonomous driving task is offloaded to a computing node with available computing resources greater than or equal to the computing resources required by that autonomous driving task.

6. The system according to claim 2, wherein:
the service dependency model comprises a directed acyclic graph (DAG) with a plurality of service nodes and a plurality of edges, and
each service node represents an autonomous driving task with an ASIL safety level required for that autonomous driving service, and
each edge represents the dependency between two connected autonomous driving tasks, with each edge arrows indicating the direction of data flow for the autonomous driving service.

7. The system according to claim 6, wherein the DAG has a plurality of root nodes representing a plurality of data input sources for the autonomous driving service.

8. The system according to claim 7, wherein the plurality of data input sources comprise two or more data input sources from cloud devices, edge devices and a vehicle.

9. The system according to claim 7, wherein the plurality of data input sources comprise a plurality of data sources from multimodal sensors.

10. The system according to claim 2, wherein:
the computing resource model comprises a bidirectional graph having a plurality of computational nodes and a plurality of edges,
each computing node has an ASIL safety level, available computing resources, and resource type, and
each edge represents the communication link between two connected computing nodes with transmission bandwidth and communication latency, and each edge allows bidirectional data transmission between the two connected computing nodes.

11. The system according to claim 2, wherein the plurality of autonomous driving tasks are offloaded once, and the computing resource model remains unchanged throughout the offloading process.

12. The system according to claim 1, wherein:
the modeling module is configured within one of the plurality of computing nodes;
the allocation module is configured within one of the plurality of computing nodes; and
the modeling module and the allocation module are configured within the same computing node or different computing nodes.

13. The system according to claim 1, wherein the allocation module is configured to:
set an objective function based on the system model; and
obtain a target offloading matrix by solving for an optimal solution of the objective function and offloading a respective autonomous driving task to one of the plurality of computing nodes based on the target offloading matrix such that:
the end-to-end latency of the autonomous driving service is minimized;
each autonomous driving task is offloaded to a computing node with an ASIL safety level higher than or equal to that required by that task;
pairs of autonomous driving tasks that depend on each other are offloaded to a pair of computing nodes with a communication latency less than the latency threshold;
each autonomous driving task is allocated to a computing node with resource types consistent with the required resources of the task; and
each autonomous driving task is offloaded to a computing node with available computing resources greater than or equal to the computing resources required by that task.

14. A method for offloading autonomous driving tasks, comprising:
creating a system model that comprises communication latency between each pair of computing nodes among a plurality of computing nodes, wherein the plurality of computing nodes comprise one or a plurality of computing nodes located on a vehicle, one or a plurality of computing nodes located on edge devices, and one or a plurality of computing nodes located on cloud devices; and
allocating a plurality of autonomous driving tasks of an autonomous driving service based on the system model in order to offload each autonomous driving task to one of the plurality of computing nodes, wherein the allocation is performed such that the end-to-end latency of the autonomous driving service is minimized.

15. A machine-readable storage medium having executable instructions stored thereon that, when executed, cause one or a plurality of processors to perform the method according to claim 14.
